(19) United States
(12) Patent Application Publication
(10) Pub. No.: US 2022/0097481 A1
(43) Pub. Date: Mar. 31, 2022

(54) AIR-CONDITIONING UNIT

(71) Applicant: DENSO CORPORATION, Kariya-city (JP)

(72) Inventors: Tetsuya KOUNO, Kariya-city (JP); Ryou KOBAYASHI, Kariya-city (JP); Shinya KATO, Kariya-city (JP)

(21) Appl. No.: 17/643,973

(22) Filed: Dec. 13, 2021

Related U.S. Application Data
(63) Continuation of application No. PCT/JP2020/023571, filed on Jun. 16, 2020.

(30) Foreign Application Priority Data
Jun. 19, 2019 (JP) 2019-113939

(51) Int. Cl. B60H 1/00

(52) U.S. Cl. CPC B60H 1/00521; B60H 1/00564

(57) ABSTRACT

An air-conditioning includes a blower, a unit casing, an upstream partition, and a fan partition. The blower includes a centrifugal fan and a fan casing. The unit casing defines an upstream passage at a position upstream of the blower. The upstream partition is fixed to the unit casing to divide the upstream passage into a first upstream passage through which a first gas flows and a second upstream passage through which a second gas flows. The fan partition is fixed to the fan casing to divide an inner space of the fan into a first fan passage through which the first gas flows and a second fan passage through which the second gas flows. The unit casing defines an opening and includes a cover that closes the opening. The opening has an opening area such that the blower is removable from the unit casing through the opening.

### CROSS REFERENCE TO RELATED APPLICATION

The present application is a continuation application of International Patent Application No. PCT/JP2020/023571 filed on Jun. 16, 2020, which designated the U.S. and claims the benefit of priority from Japanese Patent Application No. 2019-113939 filed on Jun. 19, 2019. The entire disclosures of all of the above applications are incorporated herein by reference.

### TECHNICAL FIELD

The present disclosure relates to an air-conditioning unit configured to blow conditioned air into an air-conditioning target space.

### BACKGROUND ART

In an air-conditioning unit, a partition extends from an upstream side of a fan in an airflow direction into the fan.

### SUMMARY

An air-conditioning unit configured to blow conditioned air includes a blower, a unit casing, an upstream partition, and a fan partition. The blower includes a centrifugal fan, a rotational shaft, a motor, a motor holder, and a fan casing. The centrifugal fan incudes multiple blades arranged in a circumferential direction of an axis of the blower. The rotational shaft is rotated about the axis together with the fan. The motor rotates the rotational shaft. The motor holder holds the motor. The fan casing is fixed to the motor holder to cover the centrifugal fan. The blower is housed in the unit casing. The unit casing defines therein an upstream passage at a position upstream of the blower in an airflow direction and a downstream passage at a position downstream of the blower in the airflow direction. The upstream partition is fixed to the unit casing. The upstream partition divides the upstream passage into a first upstream passage through which a first gas flows and a second upstream passage through which a second gas flows. The fan partition is fixed to the fan casing. The fan partition divides an inner space of the fan that is defined at a position radially inward of the multiple blades into a first fan passage through which the first gas from the first upstream passage flows and a second fan passage through which the second gas from the second upstream passage flows. The fan casing defines a first blowing passage through which the first gas having flowed radially outward from the first fan passage flows and a second blowing passage through which the second gas having flowed radially out from the second fan passage flows. The unit casing defines an opening facing the blower in a radial direction of the fan. The opening has an opening area such that the blower is removable from the unit casing through the opening. The unit casing includes a cover configured to close the opening. The cover can be attached and detached from the unit casing.

### BRIEF DESCRIPTION OF DRAWINGS

FIG. 1 is a cross-sectional view illustrating a configuration of an air-conditioning unit of a first embodiment.

FIG. 2 is an enlarged view of a blower in FIG. 1.

FIG. 3 is a cross-sectional view taken along a line III-III in FIG. 2.

FIG. 4 is an enlarged view of a portion of the air-conditioning unit in FIG. 1.

FIG. 5 is a cross-sectional view of the air-conditioning unit of the first embodiment with a replacement cover removed.

FIG. 6 is a partial cross-sectional view of an air-conditioning unit of a modification from the first embodiment.

FIG. 7 is a partial cross-sectional view of an air-conditioning unit of a second embodiment

FIG. 8 is a partial cross-sectional view of an air-conditioning unit of a third embodiment

FIG. 9 is a partial cross-sectional view of an air-conditioning unit of a fourth embodiment

FIG. 10 is a partial cross-sectional view of an air-conditioning unit of a fifth embodiment.

### DESCRIPTION OF EMBODIMENTS

To begin with, examples of relevant techniques will be described.

In an air-conditioning unit, a partition extends from an upstream side of a fan in an airflow direction into the fan.

In the air-conditioning unit, a temperature adjuster such as a heat exchanger may be disposed at a position downstream of a blower in the airflow direction. In this case, in order to easily replace a part or all of the blower including the fan and a motor, it is necessary to move the blower in a radial direction of the fan so that the blower can be taken out from a unit casing.

However, a concrete configuration that makes it possible to move the blower in the radial direction of the fan and take the blower out of the unit casing has not been proposed.

It is an objective of the present disclosure to provide an air-conditioning unit that has a partition arranged from an upstream side of a fan in an airflow direction to a radially inside of the fan and that enables a part or all of the blower to be replaced easily.

To achieve the above objective, according to one aspect of the present disclosure, an air-conditioning unit configured to blow conditioned air includes a blower, a unit casing, an upstream partition, and a fan partition. The blower includes a centrifugal fan, a rotational shaft, a motor, a motor holder, and a fan casing. The centrifugal fan incudes multiple blades arranged in a circumferential direction of an axis of the blower. The rotational shaft is rotated about the axis together with the fan. The motor rotates the rotational shaft. The motor holder holds the motor. The fan casing is fixed to the motor holder to cover the centrifugal fan. The blower is housed in the unit casing. The unit casing defines therein an upstream passage at a position upstream of the blower in an airflow direction and a downstream passage at a position downstream of the blower in the airflow direction. The upstream partition is fixed to the unit casing. The upstream partition divides the upstream passage into a first upstream passage through which a first gas flows and a second upstream passage through which a second gas flows. The fan partition is fixed to the fan casing. The fan partition divides an inner space of the fan that is defined at a position radially inward of the multiple blades into a first fan passage through which the first gas from the first upstream passage flows and a second fan passage through which the second gas from the second upstream passage flows. The fan casing defines a first blowing passage through which the first gas having flowed radially outward from the first fan passage flows and a second blowing passage through which the second gas having flowed radially out from the second fan passage flows. The unit casing defines an opening facing the blower in a radial direction of the fan. The opening has an opening area such that the blower is removable from the unit casing through the opening. The unit casing includes a cover configured to close the opening. The cover can be attached and detached from the unit casing.

When the fan partition is integrally formed with the upstream partition unlike the one aspect of the present disclosure, the blower is caught by the fan partition in moving the blower in the radial direction of the fan. Thus, it is impossible to move the blower in the radial direction of the fan and take the blower out of the unit casing through the opening. Therefore, it is not possible to easily replace a part or all of the blower.

In contrast, according to the one aspect of the present disclosure, the fan partition is a different member from the upstream partition. The fan partition is fixed to the motor holder through the fan casing. That is, the fan partition is fixed to the blower. Thus, even if the blower is moved along the radial direction of the fan, the blower is not caught by the fan partition. Thus, the blower can be moved along the radial direction of the fan and removed from the casing through the uncovered opening. Therefore, it is possible to easily replace a part or all of the blower.

Hereinafter, embodiments of the present disclosure will be described with reference to the drawings. In each embodiment described below, same or equivalent parts are designated with the same reference numerals.

### First Embodiment

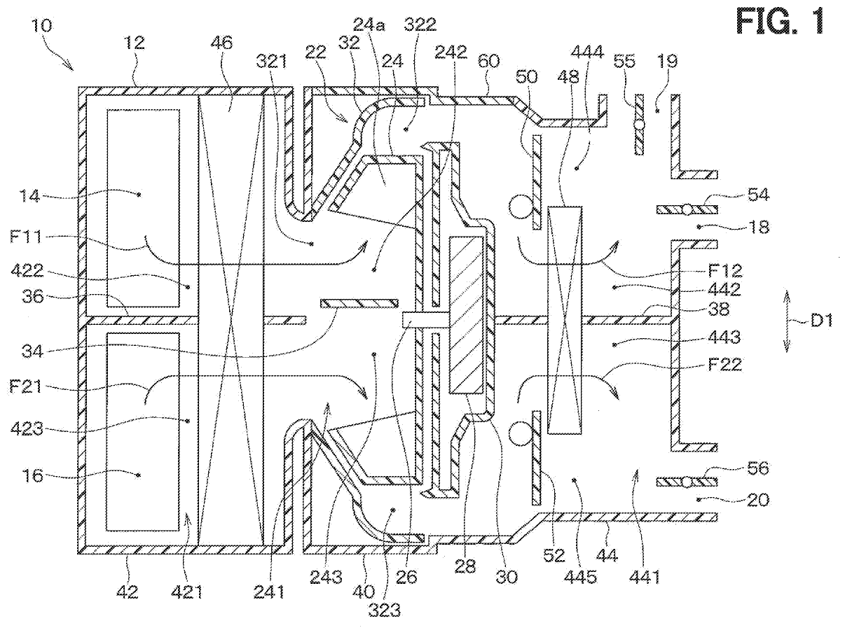

An air-conditioning unit 10 of the present embodiment shown in FIG. 1 constitutes a part of an air-conditioner mounted in a vehicle. The air-conditioning unit 10 blows conditioned air whose temperature and humidity are adjusted into a passenger compartment, which is an air-conditioning target space. The air-conditioning unit 10 is arranged inside an instrument panel that is located in the front area in the passenger compartment.

The air-conditioning unit 10 includes a unit casing 12. The unit casing 12 defines therein an air passage through which air flows toward the passenger compartment. The unit casing 12 is mainly made of a synthetic resin.

The unit casing 12 defines an external air introducing port 14 and an internal air introducing port 16 in an upstream portion of the unit casing 12 in an airflow direction. The external air introducing port 14 is an opening for introducing air outside of the passenger compartment (i.e., external air) into the unit casing 12. The internal air introducing port 16 is an opening for introducing air inside of the passenger compartment (i.e., internal air) into the unit casing 12. The external air corresponds to a first gas. The internal air corresponds to a second gas that has a different condition from the first gas. The temperature and humidity of the internal air are different from those of the external air. The external air introducing port 14 is defined in an upper portion of the unit casing 12. The internal air introducing port 16 is defined in a lower portion in the unit casing 12 than the external air introducing port 14.

The unit casing 12 defines a face opening 18, a defroster opening 19, and a foot opening 20 in a downstream portion of the unit casing 12 in the airflow direction. The face opening 18, the defroster opening 19, and the foot opening 20 are openings through which air flows out of the unit casing 12 toward the passenger compartment. The air from the face opening 18 is blown out toward an upper body of an occupant through a face outlet defined in the passenger compartment. The air from the defroster opening 19 is blown out toward a windshield through a defroster outlet defined in the passenger compartment. The air from the foot opening 20 is blown out toward the feet of the occupant. The face opening 18 and the defroster opening 19 are located in an upper portion of the unit casing 12. The foot opening 20 is located in a lower portion of the unit casing 12 than the face opening 18.

The air-conditioning unit 10 includes a blower 22. The blower 22 is housed inside the unit casing 12. The blower 22 forms an airflow inside the unit casing 12.

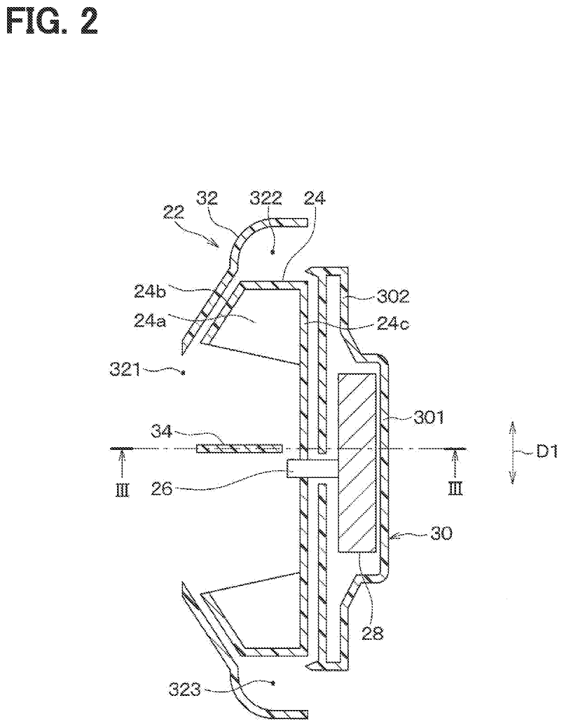

As shown in FIG. 2, the blower 22 includes a fan 24, a rotational shaft 26, a motor 28, a motor holder 30, and a fan casing 32.

The fan 24 is a centrifugal fan having blades 24a arranged in a circumferential direction of an axis of the fan 24. The fan 24 draws air in a direction along the rotational shaft 26 and blows the air outward in a radial direction D1 of the fan 24. The direction along the rotational shaft 26 includes a direction parallel to the rotational shaft 26 and a direction close to the rotational shaft 26.

More specifically, the fan 24 has a top plate portion 24b and a bottom plate portion 24c. The top plate portion 24b and the bottom plate portion 24c are arranged to face each other in the direction along the rotational shaft 26. The blades 24a are arranged between the top plate portion 24b and the bottom plate portion 24c. Each of the blades 24a is connected to both the top plate portion 24b and the bottom plate portion 24c. In FIG. 1 and the like, a portion where the blades 24a are connected to the top plate portion 24b and the bottom plate portion 24c is shown. Air flows between the adjacent ones of the blades 24a. The top plate portion 24b defines a fan suction port through which air is sucked. The bottom plate portion 24c is connected to the rotational shaft 26.

The rotational shaft 26 rotates together with the fan 24. The rotational shaft 26 is coaxial with the fan 24. The rotational shaft 26 extends along a horizontal direction. That is, the rotational shaft 26 extends in a direction parallel to the horizontal direction or nearly parallel to the horizontal direction.

The motor 28 is an electric drive unit that rotates the rotational shaft 26. The motor holder 30 holds the motor 28. The motor holder 30 includes a main body 301 that covers the motor 28 and a flange 302 that protrudes from the main body 301. The motor holder 30 is fixed to the unit casing 12 with a fixing member (not shown).

The fan casing 32 covers the fan 24 at a position outside of the fan 24 in the radial direction D1. The fan casing 32 defines a suction port 321, a first blowing passage 322 and a second blowing passage 323. The suction port 321 is an opening through which air is sucked. The first blowing passage 322 is a passage through which the external air having flowed outward in the radial direction D1 of the fan 24 from a first fan passage, which will be described later, flows. The second blowing passage 323 is a different passage from the first blowing passage 322. The second blowing passage 323 is a passage through which the internal air having flowed outward in the radial direction D1 of the fan 24 from a second fan passage, which will be described later, flows.

As shown in FIG. 1, the air-conditioning unit 10 includes a fan partition 34, an upstream partition 36, and a downstream partition 38. These partitions 34, 36, and 38 are arranged inside the unit casing 12. These partitions 34, 36, and 38 divide the air passage inside the unit casing 12 into two passages in a vertical direction.

The unit casing 12 defines therein an upstream passage 421 at a position upstream of the blower 22 in the airflow direction and a downstream passage 441 at a position downstream of the blower in the airflow direction. Specifically, the unit casing 12 includes a blower portion 40, an upstream portion 42, and a downstream portion 44. The blower portion 40 is a portion of the unit casing 12 that faces the blower 22 in the radial direction D1. The upstream portion 42 is a portion of the unit casing 12 upstream of the blower portion 40 in the airflow direction. The space inside the upstream portion 42 is the upstream passage 421. The downstream portion 44 is a portion of the unit casing 12 downstream of the blower portion 40 in the airflow direction. The space inside the downstream portion 44 is the downstream passage 441.

The upstream partition 36 is arranged inside the upstream portion 42. The upstream partition 36 divides the upstream passage 421 into a first upstream passage 422 through which the external air from the external air introducing port 14 flows and a second upstream passage 423 through which the internal air from the internal air introducing port 16 flows. The first upstream passage 422 is located in an upper portion of the upstream passage 421. The first upstream passage 422 is fluidly connected to the external air introducing port 14. The second upstream passage 423 is located lower than the first upstream passage 422. The second upstream passage 423 is fluidly connected to the internal air introducing port 16.

The fan partition 34 is arranged inside the fan 24 in the radial direction D1. That is, the fan partition 34 is arranged in an inner space 241 of the fan 24 defined radially inward of the blades 24a. The fan partition 34 divides the inner space 241 into a first fan passage 242 through which the external air from the first upstream passage 422 flows and a second fan passage 243 through which the internal air from the second upstream passage 423 flows. The second fan passage 243 is located lower than the first fan passage 242. The fan partition 34 has a flat plate shape. The fan partition 34 extends in a rotational shaft direction that is parallel to the rotational shaft 26.

The downstream partition 38 is arranged inside the downstream portion 44. The downstream partition 38 divides the downstream passage 441 into a first downstream passage 442 through which the external air from the first blowing passage 322 flows and a second downstream passage 443 through which the internal air from the second blowing passage 323 flows. The first downstream passage 442 is located in an upper portion of the downstream passage 441. The first downstream passage 442 is fluidly connected to the face opening 18 and the defroster opening 19. The second downstream passage 442 is located lower than the first downstream passage 442. The second downstream passage 443 is fluidly connected to the foot opening.

The unit casing 12, the upstream partition 36, and the downstream partition 38 are made of a synthetic resin and integrally molded with each other as a single molded product. Thus, the upstream partition 36 and the downstream partition 38 are seamlessly connected to the unit casing 12. As a result, the upstream partition 36 and the downstream partition 38 are fixed to the unit casing 12. The upstream partition 36 and the downstream partition 38 may be fixed to the unit casing 12 by being joined to the unit casing 12.

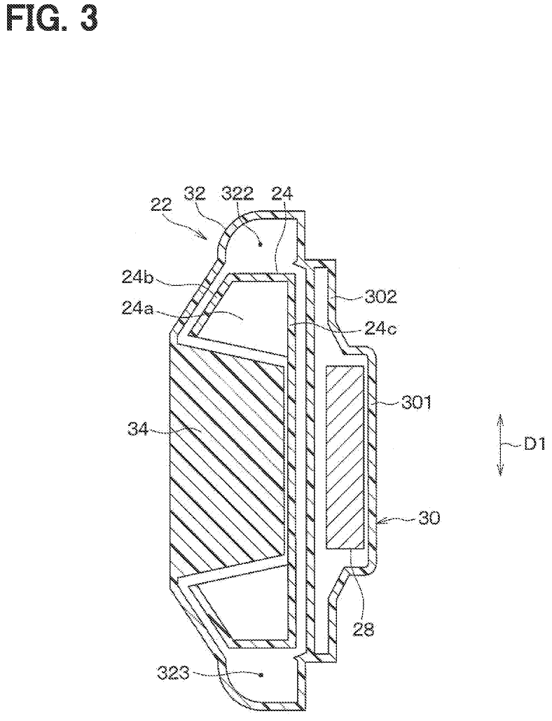

As shown in FIG. 3, the fan casing 32, the motor holder 30, and the fan partition 34 are made of a synthetic resin and integrally molded with each other as a single molded product. Thus, the fan partition 34 is seamlessly connected to the fan casing 32. The fan casing 32 is seamlessly connected to the motor holder 30. As a result, the fan partition 34 is fixed to the motor holder 30. That is, the fan partition 34 is fixed to the blower 22. The fan casing 32 may be fixed to the motor holder 30 by joining, fitting, or the like. The fan partition 34 may be fixed to the motor holder 30 by being joined to the fan casing 32.

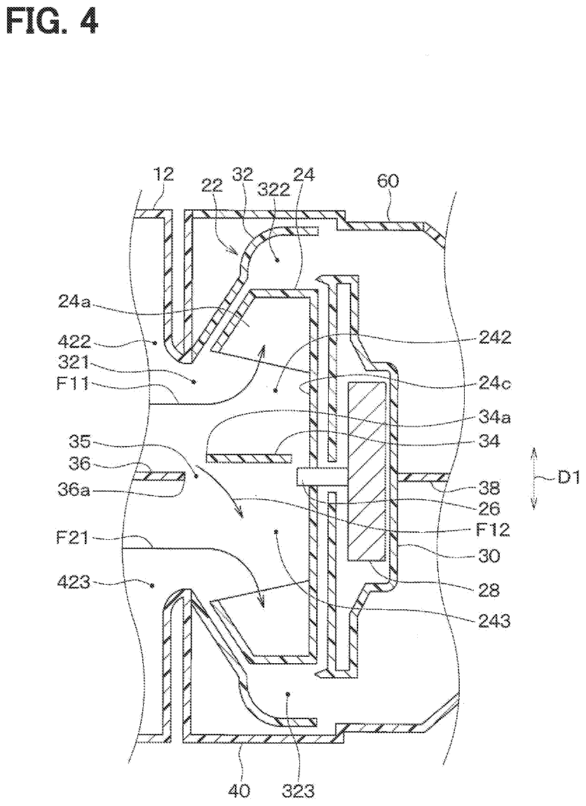

As shown in FIG. 4, the fan partition 34 has an upstream end 34a in the airflow direction that is located in the suction port 321. The upstream end 34a is an end of the fan partition 34 opposite to the motor 28 in the direction along the rotational shaft 26.

At least the downstream portion of the upstream partition 36 in the airflow direction extends in the direction along the rotational shaft 26. The upstream partition 36 has a downstream end 36a in the airflow direction that is located in the vicinity of the suction port 321. This downstream end 36a is an end of the upstream partition 36 closer to the motor 28 in the direction along the rotational shaft 26.

The upstream end 34a of the fan partition 34 in the airflow direction is located downstream of the downstream end 36a of the upstream partition 36. As a result, there is a gap 35 between the fan partition 34 and the upstream partition 36.

Further, the fan partition 34 is offset from the upstream partition 36 toward a side of the upstream partition 36 closer to the first upstream passage 422. In other words, the fan partition 34 is offset from the upstream partition 36 toward the first fan passage 242. Thus, the gap 35 is defined on a side of the upstream partition 36 closer to the first upstream passage 422.

The suction port 321 of the fan casing 32 has a peripheral edge in contact with a boundary between the blower portion 40 and the upstream portion 42. The fan casing 32 has a downstream end in the airflow direction that is in contact with a portion of the blower portion 40 between the upstream end of the blower portion 40 and a downstream end of the blower portion 40 in the airflow direction.

As shown in FIG. 1, the air-conditioning unit 10 includes an evaporator 46. The evaporator 46 is a cooling heat exchanger that evaporates a refrigerant in a refrigeration cycle and cools air through heat exchange between the refrigerant and the air. The evaporator 46 is arranged inside the upstream portion 42 of the unit casing 12. The evaporator 46 is arranged over both the first upstream passage 422 and the second upstream passage 423.

The air-conditioning unit 10 includes a heater core 48, an upper temperature-adjusting door 50, and a lower temperature-adjusting door 52. The heater core 48, the upper temperature-adjusting door 50, and the lower temperature-adjusting door 52 are temperature adjusters for adjusting the temperature of the air.

The heater core 48 is a heating heat exchanger that heats air by exchanging heat with engine cooling water. The heater core 48 is arranged inside the downstream portion 44. The heater core 48 is arranged over both the first downstream passage 442 and the second downstream passage 443. The first downstream passage 442 includes a first bypass passage 444 through which the air bypasses the heater core 48. The second downstream passage 443 includes a second bypass passage 445 through which the air bypasses the heater core 48.

The upper temperature-adjusting door 50 is arranged in the first downstream passage 442 at a position upstream of the heater core 48 and the first bypass passage 444 in the airflow direction. The upper temperature-adjusting door 50 adjusts a mixing ratio of the air flowing through the heater core 48 and the air flowing through the first bypass passage 444. Thereby, the temperature of the air is adjusted.

The lower temperature-adjusting door 52 is arranged in the second downstream passage 443 at a position upstream of the heater core 48 and the second bypass passage 445. The lower temperature-adjusting door 52 adjusts a mixing ratio of the air flowing through the heater core 48 and the air flowing through the second bypass passage 445. Thereby, the temperature of the air is adjusted.

The air-conditioning unit 10 includes a face door 54, a defroster door 55, and a foot door 56. These doors 54, 55, 56 are arranged inside the downstream portion 44. The face door 54 opens or closes the face opening 18. The defroster door 55 opens or doses the defroster opening 19. The foot door 56 opens or doses the foot opening 20.

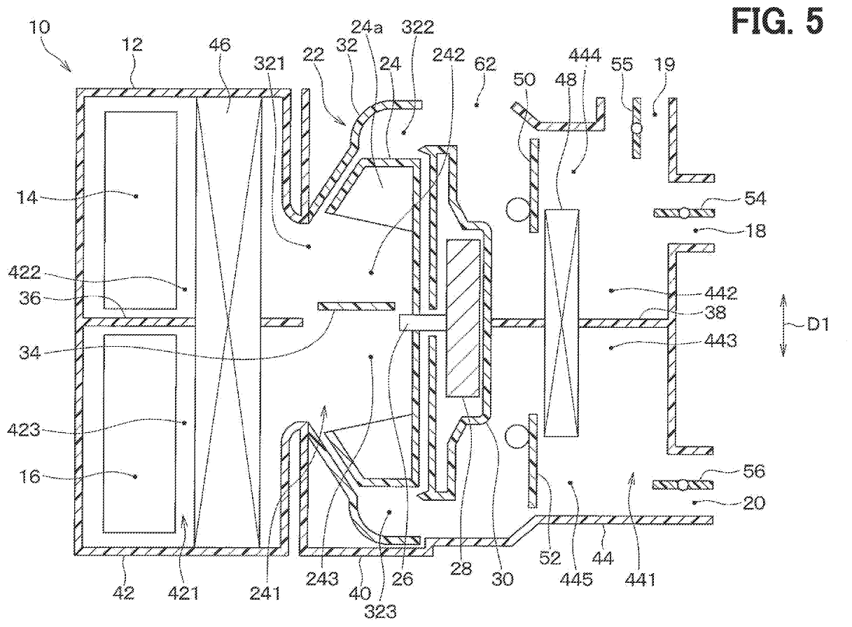

As shown in FIG. 1, the unit casing 12 has a replacement cover 60. The replacement cover 60 is a member that closes a replacement opening 62 shown in FIG. 5. The replacement cover 60 is a cover that can be attached to and detached from the unit casing 12.

The replacement opening 62 is defined in the unit casing 12. The replacement opening 62 is an opening through which the blower 22 is removed for a replacement of the blower 22 while the air conditioning unit 10 is mounted in the vehicle. That is, the replacement opening 62 is an opening having an opening area such that the blower 22 is removable from the unit casing 12 through the replacement opening 62. The replacement opening 62 is defined in a portion of the unit casing 12 facing the blower 22 in the radial direction D1. Specifically, the replacement opening 62 is formed in an upper portion of the blower portion 40. The upper portion is a portion of the blower portion 40 closer to the first fan passage 242 in a direction in which the first fan passage 242 and the second fan passage 243 are aligned.

In the air-conditioning unit 10 configured as described above, when the fan 24 rotates, as shown in arrows F11 and F12, the external air is introduced into the unit casing 12 through the external air introducing port 14 and flows through the first upstream passage 422, the first fan passage 242, the first blowing passage 322, and the first downstream passage 442. At this time, the temperature and the humidity of the external air introduced through the external air introducing port 14 is adjusted in the evaporator 46 and the heater core 48, and the external air flows out through the face opening and/or the defroster opening 19. As a result, the conditioned external air is blown toward an upper space in the passenger compartment or the windshield.

Further, as shown by arrows F21 and F22 in FIG. 1, the internal air is introduced into the internal air introducing port 16 and flows through the second upstream passage 423, the second fan passage 243, the second blowing passage 323, and the second downstream passage 443. At this time, the temperature and the humidity of the internal air introduced through the internal air introducing port 16 is adjusted in the evaporator 46 and the heater core 48, and the internal air flows out through the foot opening 20. As a result, the conditioned internal air is blown toward a lower area in the passenger compartment.

According to the air-conditioning unit 10 of the present embodiment, during heating operation in winter, external air having a lower humidity than internal air flows through the first upstream passage 422 and the first fan passage 242. Thus, low humidity air can be blown out toward the windshield. Thus, fog on the windshield can be cleared. Further, internal air having the temperature higher than that of the external air flows through the second upstream passage 423 and the second fan passage 243. As a result, the conditioned air conditioned by heating the internal air can be blown toward the passenger compartment. Thus, heating efficiency can be improved compared to a case that the conditioned airformed by heating external air is blown toward the passenger compartment.

In the air-conditioning unit 10 of the present embodiment, only external air is introduced into the first upstream passage 422. Only internal air is introduced into the second upstream passage 423. However, the air-conditioning unit 10 may be configured such that one of the internal air and the external air is selectively introduced into the first upstream passage 422 and one of the internal air and the external air is selectively introduced into the second upstream passage 423. For example, the internal air may be introduced into both the first upstream passage 422 and the second upstream passage 423. Further, the external air may be introduced into both the first upstream passage 422 and the second upstream passage 423.

Nest, advantages of the present embodiment will be described.

(1) In the present embodiment, the air-conditioning unit 10 includes the fan partition 34 and the upstream partition 36 as a partition arranged from the upstream side of the fan 24 in the airflow direction to the inside of the fan 24. The fan partition 34 is fixed to the blower 22. The upstream partition 36 is fixed to the upstream portion 42. Further, the unit casing 12 defines the replacement opening 62. The unit casing 12 has the replacement cover 60.

When the fan partition 34 are integrally formed with the upstream partition 36 unlike the present embodiment and when the blower 22 is moved in the radial direction D1, the blower is caught by the fan partition 34. Thus, it is impossible to move the blower 22 in the radial direction D1 and remove the blower 22 from the unit casing 12 thorough the replacement opening 62. Therefore, it is not possible to easily replace the parts of the blower 22.

In contrast, according to the present embodiment, the fan partition 34 is a different member from the upstream partition 36. The fan partition 34 is fixed to the motor holder 30 through the fan casing 32. In this way, the fan partition 34 is fixed to the blower 22. Thus, even if the blower 22 is moved in the radial direction D1, the blower 22 is not caught by the fan partition 34. Thus, the blower 22 can be moved in the radial direction D1 and taken out from the unit casing 12 through the replacement opening 62 with the replacement cover 60 removed from the replacement opening 62. Therefore, a part or all of the blower 22 can be easily replaced.

(2) In the present embodiment, as shown in FIG. 4, the fan partition 34 defines the gap 35 between the fan partition 34 and the upstream partition 36. The fan partition 34 is arranged to be offset from the upstream partition 36 toward the first upstream passage 422.

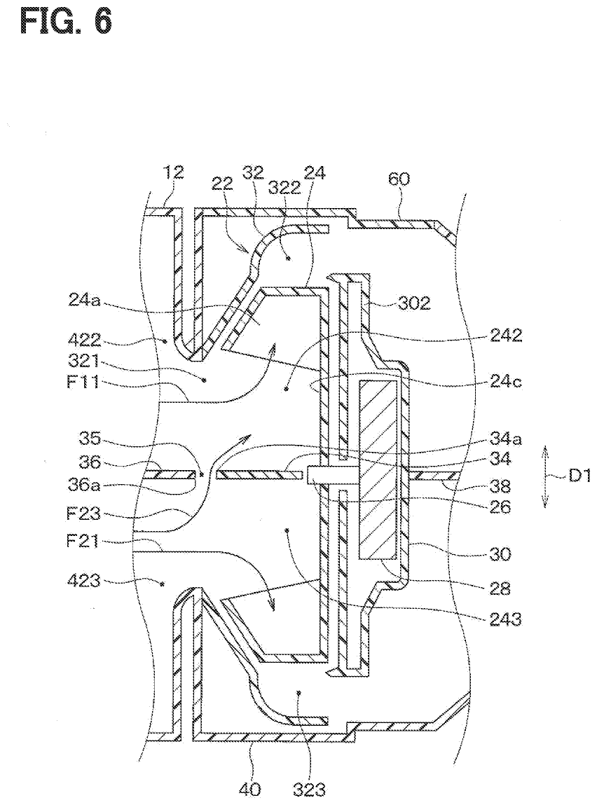

However, as shown in FIG. 6, the fan partition 34 may be arranged at the same position as the upstream partition 36 in a direction intersecting a main surface of the upstream partition 36. Even in this case, the advantage (1) described above can be obtained.

However, in this case, as shown by the arrow F23 in FIG. 6, a part of the internal air flowing through the second upstream passage 423 may flow into the first fan passage 242 through the gap 35. During heating operation in winter, as for cleaning fog on the windshield, it is not preferable that air having higher humidity than that of the external air be mixed with the external air flowing through the first upstream passage 422 and the first fan passage 242.

In contrast, according to the present embodiment, as shown in FIG. 4, the gap 35 is formed on the side of the upstream partition 36 closer to the first upstream passage 422. Thus, as shown in F12 in FIG. 4, a part of the external air flowing through the first upstream passage 422 flows into the second fan passage 243 through the gap 35. The dynamic pressure of the external air flowing through the gap 35 can prevent the internal air from flowing into the gap 35. Thus, it is possible to prevent a part of the internal air flowing through the second upstream passage 423 from flowing into the first fan passage 242 through the gap 35. It is possible to prevent the internal air from being mixed into the external air.

### Second Embodiment

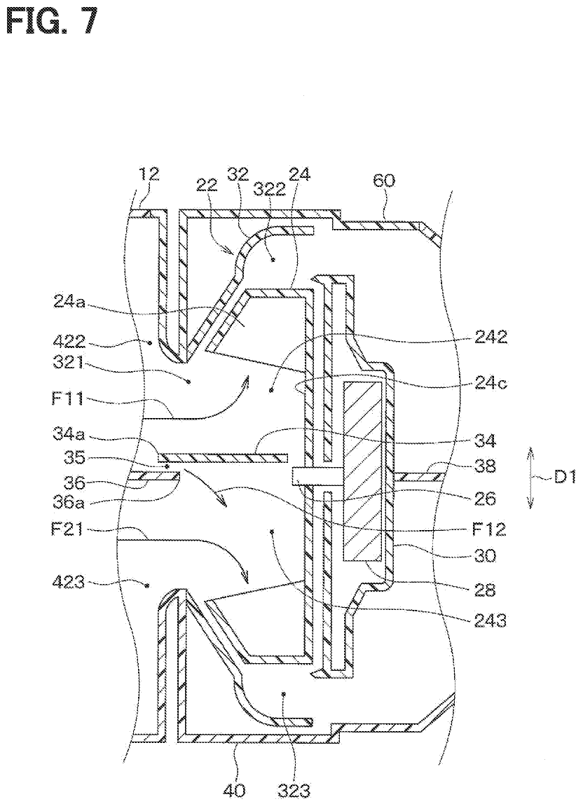

As shown in FIG. 7, in the present embodiment as in the first embodiment, the fan partition 34 defines the gap 35 between the fan partition 34 and the upstream partition 36. The fan partition 34 is arranged to be offset from the upstream partition 36 toward the first upstream passage 422. Further, unlike the first embodiment, the upstream end 34a of the fan partition 34 in the airflow direction is disposed upstream of the downstream end 36a of the upstream partition 36 in the airflow direction.

The upstream end 34a of the fan partition 34 in the airflow direction is located upstream of the fan casing 32 in the airflow direction. The upstream end of the replacement cover 60 in the airflow direction is located upstream of the fan casing 32 such that the blower 22 can be moved in the radial direction D1 and taken out from the unit casing 12.

The other configurations of the air-conditioning unit 10 are similar to those of the first embodiment. The same advantages as those of the first embodiment can be obtained in this embodiment. However, in the present embodiment, in order for the internal air to flow into the first upstream passage 422 and the first fan passage 242, the internal air has to flow through the gap 35 in a direction opposite to a flow direction of the external air flowing through the first upstream passage 422. Thus, according to the present embodiment, the internal air is reliably restricted from flowing into the first fan passage 242 through the gap 35.

### Third Embodiment

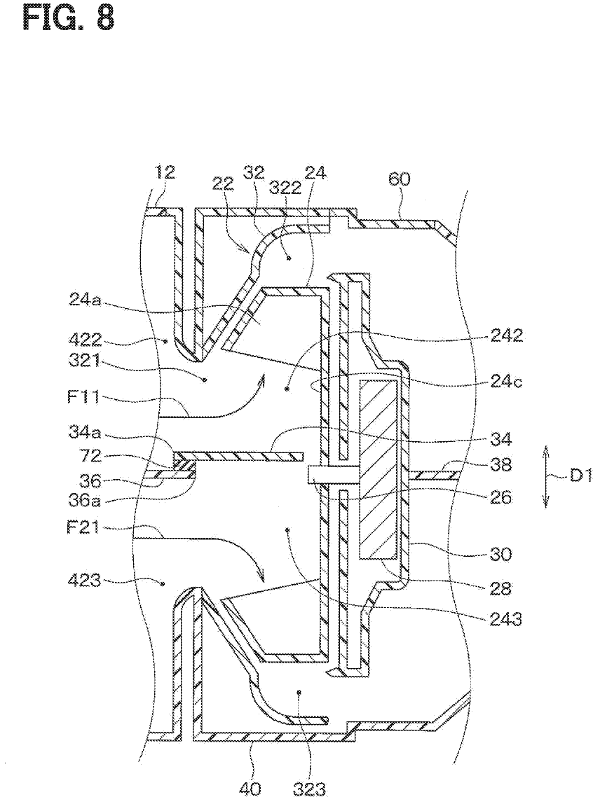

As shown in FIG. 8, in the present embodiment, the air-conditioning unit 10 includes a sealing member 72 for closing the gap between the fan partition 34 and the upstream partition 36.

The sealing member 72 is made of a synthetic rubber or the like. The sealing member 72 is fixed to the surface of the upstream end of the fan partition 34 facing the second upstream passage 423 by joining and the like. The sealing member 72 is pressed against the surface of the upstream partition 36 facing the first upstream passage 422. As a result, the sealing member 72 is interposed between the upstream partition 36 and the fan partition 34 in a direction intersecting an extending direction of the fan partition 34.

The other configurations of the air-conditioning unit 10 are similar to those of the first embodiment. Therefore, the advantage (1) of the first embodiment can be obtained also in this embodiment. Further, according to the present embodiment, the sealing member 72 closes the gap between the fan partition 34 and the upstream partition 36. Thus, the internal air and the external air are restricted from leaking through the gap between the fan partition 34 and the upstream partition 36. It is possible to prevent the internal air and the external air from being mixed with each other.

In this embodiment, the sealing member 72 is fixed to the fan partition 34. However, the sealing member 72 may be fixed to the upstream partition 36 instead of the fan partition 34.

### Fourth Embodiment

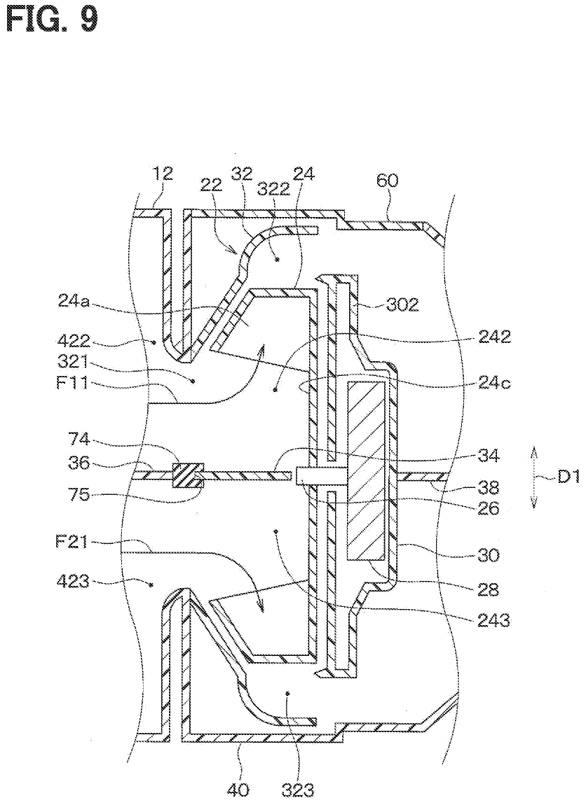

As shown in FIG. 9, in the present embodiment, the air-conditioning unit 10 includes a sealing member 74 for closing the gap between the fan partition 34 and the upstream partition 36.

The sealing member 74 is made of a synthetic rubber or the like. The sealing member 74 is fixed to the downstream end of the upstream partition 36 by joining or the like. The downstream end of the sealing member 74 defines a recess 75. The upstream end of the fan partition 34 is inserted into the recess 75 of the sealing member 74. As a result, the sealing member 74 is interposed between the upstream partition 36 and the fan partition 34 in the direction along the rotational shaft 26.

The other configurations of the air-conditioning unit 10 are similar to those of the first embodiment. Therefore, the advantage (1) of the first embodiment can be obtained also in this embodiment. Further, according to the present embodiment, the sealing member 74 closes the gap between the fan partition 34 and the upstream partition 36. Thus, similar advantages to those of the third embodiment can be obtained.

In this embodiment, the sealing member 74 is fixed to the upstream partition 36. However, the sealing member 74 may be fixed to the fan partition 34 instead of the upstream partition 36.

### Fifth Embodiment

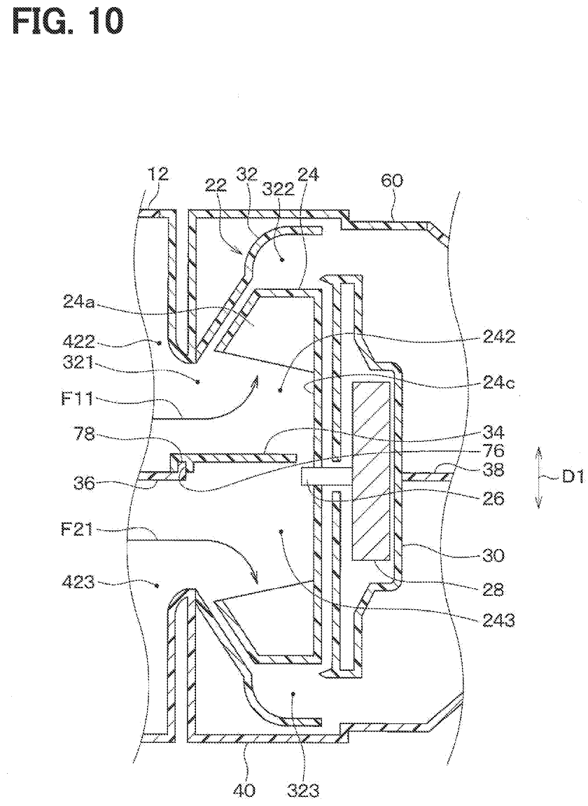

As shown in FIG. 10, in the present embodiment, the fan partition 34 has a first engaging portion 76 configured to detachably engage with the upstream partition 36. The first engaging portion 76 is formed in the upstream end of the fan partition 34. The first engaging portion 76 is made of a resin and integrally formed with the fan partition 34. The first engaging portion 76 is a recess that has an elongated shape.

The upstream partition 36 has a second engaging portion 78 configured to detachably engage with the fan partition 34. The second engaging portion 78 is formed in the downstream end of the upstream partition 36. The second engaging portion 78 is made of a resin and integrally formed with the upstream partition 36. The second engaging portion 78 is a protrusion having a shape that can be fit into the recess.

When the blower 22 is replaced, the fan partition 34 is moved away from the upstream partition 36 in the direction intersecting the extending direction of the upstream partition 36. As a result, the first engaging portion 76 is disengaged from the second engaging portion 78. On the other hand, when the fan partition 34 is moved toward the upstream partition 36 in the direction intersecting the extending direction of the upstream partition 36, the first engaging portion 76 is engaged with the second engaging portion 78.

The other configurations of the air-conditioning unit 10 are similar to those of the first embodiment. Therefore, the advantage (1) of the first embodiment can be obtained also in this embodiment. Further, according to the present embodiment, the gap between the fan partition 34 and the upstream partition 36 is closed by engagement of the first engaging portion 76 and the second engaging portion 78. Thus, the internal air and the external air are restricted from leaking through the gap between the fan partition 34 and the upstream partition 36. It is possible to prevent the internal air and the external air from being mixed with each other.

### Other Embodiments

(1) In each of the above embodiments, the evaporator 46 is arranged upstream of the blower 22 in the airflow direction. However, the evaporator 46 may be arranged downstream of the blower 22 in the airflow direction.

(2) In each of the above embodiments, the blower 22 is entirely covered with the unit casing 12. However, a part of the blower 22, for example, the fan casing 32 may be exposed from the unit casing 12.

(3) In each of the above embodiments, the first gas is the external air and the second gas is the internal air. However, the first gas and the second gas are not limited to this. The first gas and the second gas may be any gas as long as they have different conditions such as temperature and humidity.

(4) In each of the above embodiments, the air-conditioning unit 10 is a vehicle air-conditioning unit mounted in a vehicle. However, the air-conditioning unit 10 may be mounted in something other than a vehicle. Examples of things other than the vehicle include moving objects other than the vehicle, buildings, and the like.

(5) The present disclosure is not limited to the foregoing description of the embodiments and can be modified. The present disclosure may also be varied in many ways. Such variations are not to be regarded as departure from the disclosure, and all such modifications are intended to be included within the scope of the disclosure. The above embodiments are not independent of each other, and can be appropriately combined except when the combination is obviously impossible. Further, in each of the above-mentioned embodiments, it goes without saying that components of the embodiment are not necessarily essential except for a case in which the components are particularly clearly specified as essential components, a case in which the components are clearly considered in principle as essential components, and the like. A quantity, a value, an amount, a range, or the like, if specified in the above-described example embodiments, is not necessarily limited to the specific value, amount, range, or the like unless it is specifically stated that the value, amount, range, or the like is necessarily the specific value, amount, range, or the like, or unless the value, amount, range, or the like is obviously necessary to be the specific value, amount, range, or the like in principle. Furthermore, a material, a shape, a positional relationship, or the like, if specified in the above-described example embodiments, is not necessarily limited to the specific material, shape, positional relationship, or the like unless it is specifically stated that the material, shape, positional relationship, or the like is necessarily the specific material, shape, positional relationship, or the like, or unless the material, shape, positional relationship, or the like is obviously necessary to be the specific material, shape, positional relationship, or the like in principle.

(Overview)

According to the first aspect shown in a part or all of the above-described embodiments, the air-conditioning unit configured to blow conditioned air includes a blower, a unit casing, a first upstream passage, a upstream partition, and a fan partition. The blower includes a centrifugal fan, a rotational shaft, a motor, a motor holder, and a fan casing. The centrifugal fan includes multiple blades arranged in a circumferential direction of an axis of the blower. The rotational shaft is rotated about the axis together with the fan. The motor rotates the rotational shaft. The motor holder holds the motor. The fan casing is fixed to the motor holder to cover the fan. The unit casing houses the blower. The unit casing defines therein an upstream passage at a position upstream of the blower in an airflow direction and a downstream passage at a position downstream of the blower in the airflow direction. The upstream partition is fixed to the unit casing and divides the upstream passage into a first upstream passage through which a first gas flows and a second upstream passage through which a second gas flows. The fan partition is fixed to the fan casing and divides an inner space of the fan that is defined at a position radially inward of the multiple blades into a first fan passage through which the first gas from the first upstream passage flows and a second fan passage through which the second gas from the second upstream passage flows. The fan casing defines a first blowing passage through which the first gas having flowed radially outward from the first fan passage flows and a second blowing passage through which the second gas having flowed radially outward from the second fan passage flows. The unit casing defines an opening facing the blower in the radial direction of the fan. The opening has an opening area such that the blower is removable from the unit casing through the opening. The unit casing includes a cover configured to close the opening. The cover can be attached and detached from the unit casing.

Further, according to a second aspect, the fan partition is arranged to be offset from the upstream partition toward the first upstream passage to define a gap between the fan partition and the upstream partition. According to this, a part of the first gas flowing through the first upstream passage flows into the second fan passage through the gap. This restricts the second gas from flowing into the first fan passage through the gap. It is possible to prevent the second gas from being mixed with the first gas flowing through the first passage.

Further, according to the third aspect, the upstream end of the fan partition is located upstream of the downstream end of the upstream partition in the airflow direction. According to this, in order for the second gas to flow into the first fan passage through the gap, the second gas has to flow through the gap in a direction opposite to a flow direction of the first gas flowing through the first passage. Therefore, it is possible to more reliably prevent the second gas from flowing into the first fan passage through the gap.

Further, according to the fourth aspect, the air-conditioning unit is mounted in a vehicle. The first gas is air outside of a passenger compartment. The second gas is air inside of the passenger compartment. In the case of the fourth aspect, according to the second and third aspects, it is possible to prevent the internal air from being mixed with the external air flowing through the first fan passage.

Further, according to the fifth aspect, the air-conditioning unit includes a sealing member for closing the gap between the fan partition and the upstream partition. According to this, the first gas or the second gas is restricted from leaking through a space between the fan partition and the upstream partition. It is possible to prevent the first gas and the second gas from being mixed with each other.

Further, according to the sixth aspect, the fan partition includes a first engaging portion. The upstream partition includes a second engaging portion. The first engaging portion and the second engaging portion are detachably engaged with each other. According to this, the first gas or the second gas is restricted from leaking through a gap between the fan partition and the upstream partition. It is possible to prevent the first gas and the second gas from being mixed with each other.

What is claimed is:

1. An air-conditioning unit configured to blow a conditioned air, the air-conditioning unit comprising:
a blower including:
a centrifugal fan having a plurality of blades that are arranged in a circumferential direction of an axis of the blower,
a rotational shaft configured to be rotated about the axis together with the centrifugal fan;
a motor configured to rotate the rotational shaft;
a motor holder holding the motor; and
a fan casing fixed to the motor holder to cover the centrifugal fan;
a unit casing in which the blower is housed, the unit casing defining therein:
an upstream passage at a position upstream of the blower in an airflow direction; and
a downstream passage at a position downstream of the blower in the airflow direction;
an upstream partition fixed to the unit casing to divide the upstream passage into a first upstream passage through which a first gas flows and a second upstream passage through which a second gas flows; and
a fan partition fixed to the fan casing to divide an inner space of the fan that is defined at a position radially inward of the plurality of blades into a first fan passage through which the first gas from the first upstream passage flows and a second fan passage through which the second gas from the second upstream passage flows, wherein
the fan casing defines:
a first blowing passage through which the first gas having flowed radially outward from the first fan passage flows; and
a second blowing passage through which the second gas having flowed radially outward from the second fan passage flows,
the unit casing defines an opening facing the blower in a radial direction of the fan, and
the unit casing includes a cover configured to close the opening, the cover being detachably attached to the unit casing, wherein
the opening has an opening area such that the blower is removable from the unit casing through the opening.

2. The air-conditioning unit according to claim 1, wherein
the fan partition is offset from the upstream partition toward the first upstream passage to define a gap between the fan partition and the upstream partition.

3. The air-conditioning unit according to claim 2, wherein
the fan partition has an upstream end in the airflow direction, and
the upstream end of the fan partition is located at a position upstream of a downstream end of the upstream partition in the airflow direction.

4. The air-conditioning unit according to claim 2, wherein
the air-conditioning unit is disposed in a vehicle,
the first gas is an air outside of the vehicle, and
the second gas is an air inside of the vehicle.

5. The air-conditioning unit according to claim 1 further comprising
a sealing member configured to seal a gap between the fan partition and the upstream partition.

6. The air-conditioning unit according to claim 1, wherein
the fan partition includes a first engaging portion,
the upstream partition includes a second engaging portion, and
the first engaging portion and the second engaging portion are detachably engaged with each other.
